(19) United States
(12) Patent Application Publication
(10) Pub. No.: US 2022/0338509 A1
(43) Pub. Date: Oct. 27, 2022

(54) METHODS FOR PREPARING CANNABINOID COMPOSITIONS

(71) Applicant: M&M INNOVATION LTD, Yardley Hastings Northamptonshire (GB)

(72) Inventors: Martin KAPROCKYJ, Olney (GB); Michael FITZGERALD, Olney (GB)

(21) Appl. No.: 17/639,455

(22) PCT Filed: Nov. 11, 2020
(86) PCT No.: PCT/EP2020/081771

§ 371 Date: Mar. 1, 2022

(30) Foreign Application Priority Data
Nov. 19, 2019 (GB) 1916829.3

(51) Int. Cl. A23L 2/52; A23F 3/34; A23L 33/105

(52) U.S. Cl. CPC A23L 2/52; A23F 3/34; A23L 33/105; A23V 2002/00

(57) ABSTRACT

The present invention relates generally to a method of preparing cannabinoid containing composition and in particular cannabinoid containing composition where the composition comprises a mixture of hemp biomass and seeds material and products comprising the composition and use of the products and the composition.

### FIELD OF THE INVENTION

The present invention relates generally to a method of preparing cannabinoid containing composition and in particular cannabinoid containing composition where the composition comprises a mixture of hemp biomass and seeds material and products comprising the composition and use of the composition.

### BACKGROUND

Over 110 phytocannabinoids (cannabinoids) have been isolated from the dioecious plants of the genus Cannabis. Of these, the primary psychoactive compound is delta-9 tetrahydro-cannabinol, commonly known as THC. Another major phytocannabinoid is cannabidiol, commonly abbreviated as CBD which is a non-psychoactive compound. There is a wide range of THC and CBD potency between Cannabis plant varieties and different varieties of plants are being selected according to the desired applications. Current research has shown that Cannabis is monotypic and consists of a single species Cannabis sativa L. Within this species there are recognised three subspecies: Industrial hemp Cannabis sativa (Cannabis sativa subspecies sativa) L., Indian hemp (Cannabis sativa subspecies indica) Lam., and ruderal hemp (Cannabis sativa subspecies spontanea). The extent of Cannabis domestication has been so persistent to cause the disappearing of the wild species: nowadays, the specie(s) belonging to the genus Cannabis are represented by myriads of cultivated varieties, which occasionally escape cultivation and grow also in the wild, giving life to forms that lose some features typical of cultivated ones.

In recent years, CBD has been attracting increased attention by the health-conscious communities around the globe. This growth has been fueled largely by fundamental research which have systematically shown how CBD may help people deal with chronic pain, anxiety, stress, migraines, and many other health-related issues.

Dried Cannabis is considered by many to be the main form of Cannabis and is suitable for smoking or vaporizing. However, Cannabis products other than dried Cannabis flower have gained increasing market size and share. For instance, Cannabis extract, may be extracted by suitable means and formulated into a wide variety of products that are suitable for eating, drinking, topical application, transmucosal absorption or even vaporizing.

Cannabinoids are hydrophobic (water-hating) oily substances and, as such, not water-soluble. The lack of solubility of cannabinoids creates problems when trying to create consumer products which rely, for example, on Cannabis extracts. Cannabis extract may be obtained from Cannabis plant matter by a variety of techniques for instance using solvents such as CO2, alcohols and hydrocarbons or through solvent free means such as pressure. Removing the solvents would increase the cost of the consumer products as well as limit the breadth of applications.

The flavour of Cannabis is also considered to be a negative in many markets. Strong flavours, such as those found in soft drinks, fruit beverages and iced tea, are often used to camouflage the flavour of Cannabis and in some cases of a carrier oil or emulsion used in the Cannabis extract.

Although less commonly practiced than popular methods like smoking or consuming edibles, drinking Cannabis tea can produce comparable physical and mental therapeutic effects as a consequence of its biological activities. Cannabis tea is commonly prepared by steeping various parts of the Cannabis plant in hot or cold water. The effects of cannabinoid are largely attributed to the THC content of the tea, levels of which are affected by individual preparation techniques, amount of Cannabis, boiling time and volume (Hazekamp, Arno (2017). “Cannabis tea revisited: A systematic evaluation of the cannabinoid composition of Cannabis tea”. Journal of Ethnopharmacology. 113 (1): 85-90). The authors recognize that the quality of the cannabinoid product and the flavour or bitterness of Cannabis tea is affected by factors such as the source of the Cannabis plant, methods of preparation of the plant material, duration of time over which the Cannabis is steeped, the volume of tea prepared and the period of time for which the tea is stored before consumption.

Therefor there is a need to develop cannabinoid containing compositions which are easy to use and readily overcome at least some of the above problems.

### SUMMARY

Disclosed herein is a method for preparing cannabinoid containing compositions which are not only easy to use but also have the desired biological activities. Disclosed herein is also a cannabinoid product the product containing compositions which are not only easy to use but also have the desired biological activities.

It was unexpectedly and surprisingly observed that using the methods described herein, it is possible to prepare cannabinoid containing compositions which overcome at least some of the problems associated with cannabinoids such as for example their lack of water solubility.

According to one aspect, there is provides a method for preparing a cannabinoid containing composition, the method comprising the steps of providing hemp plant biomass and seeds material; and mixing the hemp plant biomass and the seeds material to a predetermined ratio of hemp plant biomass to seeds material.

In some embodiments, the method for preparing the cannabinoid containing composition comprises hemp plant biomass which has less than about 20% moisture content (MC).

In some embodiments the method for preparing the cannabinoid containing composition comprises hemp plant biomass which less than about 18% MC. In some embodiments the method for preparing the cannabinoid containing composition comprises hemp plant biomass which has less than about 16% MC. In some embodiments the method for preparing the cannabinoid containing composition comprises hemp plant biomass which has less than about 14% MC. In some embodiments the method for preparing the cannabinoid containing composition comprises hemp plant biomass which has less than about 12% MC. In some embodiments the method for preparing the cannabinoid containing composition comprises hemp plant biomass which has less than about 10% MC.

In an embodiment, the method for preparing the cannabinoid containing composition comprises hemp plant biomass which has about 12% MC. In one embodiment the method for preparing the cannabinoid containing composition comprises hemp plant biomass which has 12% MC.

In some embodiments, the method for preparing the cannabinoid containing composition comprises seeds material. In some embodiments the method for preparing the cannabinoid containing composition comprises seeds material which has less than about 20% moisture content (MC). In some embodiments the method for preparing the cannabinoid containing composition comprises seeds material which has less than about 18% MC. In some embodiments the method for preparing the cannabinoid containing composition comprises seeds material which has less than about 16% MC. In some embodiments the method for preparing the cannabinoid containing composition comprises hemp plant seeds material which has less than about 14% MC. In some embodiments the method for preparing the cannabinoid containing composition comprises seeds material which has less than about 12% MC. In some embodiments the method for preparing the cannabinoid containing composition comprises seeds material which has less than about 10% MC.

In an embodiment, the method for preparing the cannabinoid containing composition comprises seeds material which has about 12% MC. In one embodiment, the method for preparing the cannabinoid containing composition comprises seeds material which has 12% MC.

In some embodiments the method for preparing a cannabinoid containing composition according to the present invention comprises further treating the hemp plant biomass and the seeds material.

In some embodiments the hemp plant biomass and the seeds material are treated separately, sequentially or concomitantly.

In some embodiments the hemp plant biomass or the seeds material are treated by physical agitation. In some embodiments the hemp plant biomass or the seeds material are treated by the application of pressure. In some embodiments the hemp plant biomass or the seeds material are treated with mechanical means. In some embodiments the hemp plant biomass or the seeds material are treated with sonication. In some embodiments the hemp plant biomass or the seeds material are treated with pneumatic pressure. In some embodiments the hemp plant biomass or the seeds material are treated with hydraulic pressure. In some embodiments the hemp plant biomass and the seeds material are treated before drying. In some embodiments the hemp plant biomass and the seeds material are treated after drying.

In some embodiments the hemp plant biomass and the seeds material are subjected to air drying.

In some embodiments the hemp plant biomass or the seeds material are treated during harvesting. In some embodiments the hemp plant biomass or the seeds material are treated immediately after harvesting.

In some embodiments, after treatment, at least 50% of the integrity of the hemp plant biomass and the seeds material is disrupted. In some embodiments, after treatment, at least 60% of the integrity of the hemp plant biomass and the seeds material is disrupted. In some embodiments, after treatment, at least 70% of the integrity of the hemp plant biomass and the seeds material is disrupted. In some embodiments, after treatment, at least 80% of the integrity of the hemp plant biomass and the seeds material is disrupted. In some embodiments, after treatment, at least 90% of the integrity of the hemp plant biomass and the seeds material is disrupted. In some embodiments, after treatment, at least 95% of the integrity of the hemp plant biomass and the seeds material is disrupted. In some embodiments, after treatment, at least 97.5% of the integrity of the hemp plant biomass and the seeds material is disrupted. In some embodiments, after treatment, at least 99% of the integrity of the hemp plant biomass and the seeds material is disrupted. In some embodiments, after treatment, 100% of the integrity of the hemp plant biomass and the seeds material is disrupted.

The seeds material can be derived from any plant. In some embodiments the plant from which the seeds material is derived can be selected from the group consisting of cereals, pseudocereals, legumes, nuts or other seeds.

In some embodiments the plant from which the seeds material is derived can be selected from the group consisting of sunflower, pumpkin, jackfruit, cempedak, cocoa, coffee, durian, fox nut, hemp, lotus, poppy, pomegranate, watermelon, stone pine, single-leaf pinyon, Mexican pinuon, Korean pine, chingoza pine, pine nuts, monkey-puzzle, juniper, gnetum, ginkgo and cycads.

In some embodiments the seeds material comprises immature seeds, mature seeds, hard seed, fragmented seeds or shattered seeds.

In some embodiments the seeds material comprises lipid molecules. In some embodiments the lipid molecules comprise fatty acids such as Omega-6 and Omega-3 fatty acids, linoleic acid and alpha-linolenic acid.

In some embodiments, the seed material contains fatty acids selected from the group consisting of Omega fatty acids, Omega-6 and Omega-3, linoleic acid, alpha-linolenic, oleic acid and other mono-unsaturated, polyunsaturated and saturated fatty acids.

In some embodiments the seeds material contains over 30% lipid. In some embodiments the material contains over 31% lipid. In some embodiments the seeds material contains over 32% lipid. In some embodiments the seeds material contains over 33% lipid. In some embodiments the seeds material contains over 34%, 35%, 36%, 37%, 38%, 39%, 40% lipid.

It is contemplated that the growth stage of the plant from which the seeds material is derived or the time of harvesting of the plant may not affect the cannabinoid containing composition and any subsequent uses of the cannabinoid containing composition. It is contemplated that the growth stage of the plant from which the seeds material is derived or the time of harvesting of the plant may affect the cannabinoid containing composition and any subsequent uses of the cannabinoid containing composition.

In some embodiments the seeds material is derived from a sunflower plant. In some embodiments the seeds material comprises sunflower seeds.

In some embodiments the seeds material is derived from pumpkin plant. In some embodiments the seeds material comprises pumpkin seeds.

In some embodiments, the seeds material is derived from a hemp plant. In some embodiments the seeds material comprises hemp plant seeds material.

As used herein, the term “hemp plant seeds material” means bracts, grains or seeds derived from a hemp plant. By way of example, the hemp seeds material may be immature seeds, mature seeds, hard seed or shattered seeds. In some embodiments the hemp plant seeds material comprises hemp bracts. In some embodiment the hemp plant seeds material comprises hemp grains. In some embodiments the hemp plant seeds material comprises hemp seeds. In some embodiments the hemp plant seeds material comprises a mixture of hemp bracts, hemp grains or hemp seeds. The fat or lipid molecular such as fatty acids, which can be found in hemp seeds are for example Omega-6 and Omega-3 fatty acids, linoleic acid and alpha-linolenic acid. In some embodiments, the hemp plant seed material contains fatty acids selected from the group consisting of Omega-6 and Omega-3 fatty acids, linoleic acid and alpha-linolenic acid.

Without wishing to be bound by theory, it is contemplated that the growth stage of the hemp plant or the time of harvesting of the hemp plant, characterised as a dioecious plant (Zadoks et al., (1974) Weed Research 14: 415-421; Mediavilla et al., 1998, Journal of the International Hemp Association 5(2):65, 68-74)), can affect the cannabinoid containing composition and any subsequent uses of the cannabinoid containing composition.

In some embodiments, the hemp plant biomass is obtained from hemp plants which are at any one or more of the growth stages selected from the group of 2202, 2203, 2204 and 2205 (Zadoks et al., (1974) and Examples Section).

In some embodiments, where the seeds material is derived from hemp plant, the hemp plant is obtained from any one or more of the growth stages selected from the group of 2202, 2203, 2204 and 2205 (Zadoks et al., (1974) and Examples Section).

In some embodiments, hemp plant growth stage 2202 can represent a hemp plant where at least 50% of the hemp plant bracts or flowers are formed. In some embodiments hemp plant growth stage 2202 can represent a hemp plant where at least 55% of the hemp plant bracts or flowers are formed. In some embodiments hemp plant growth stage 2202 can represent a hemp plant where at least 60% of the hemp plant bracts or flowers are formed. In some embodiments hemp plant growth stage 2202 can represent a hemp plant where at least 65% of the hemp plant bracts or flowers are formed. In some embodiments hemp plant growth stage 2202 can represent a hemp plant where at least 70% of the hemp plant bracts or flowers are formed. In some embodiments hemp plant growth stage 2202 can represent a hemp plant where at least 75% of the hemp plant bracts or flowers are formed.

In one embodiment, hemp plant growth stage 2202 represents a hemp plant where at least 50% of the hemp plant bracts or flowers are formed.

In some embodiments, hemp plant growth stage 2203 can represent a stage where hemp plant maturity has started and seeds start to harden. In some embodiments hemp plant growth stage 2203 can represent a stage where maturity has started and seeds start to harden in less than 5% of the hemp plants. In some embodiments hemp plant growth stage 2203 can represent a stage where maturity has started and seeds start to harden in less than 10% of the hemp plants. In some embodiments hemp plant growth stage 2203 can represent a stage where maturity has started and seeds start to harden in less than 15% of the hemp plants. In some embodiments hemp plant growth stage 2203 can represent a stage where maturity has started and seeds start to harden in less than 20% of the hemp plants. In some embodiments hemp plant growth stage 2203 can represent a stage where maturity has started and seeds start to harden in less than 25% of the hemp plants. In some embodiments hemp plant growth stage 2203 can represent a stage where maturity has started and seeds start to harden in less than 30% of the hemp plants. In some embodiments hemp plant growth stage 2203 can represent a stage where maturity has started and seeds start to harden in less than 35% of the hemp plants. In some embodiments hemp plant growth stage 2203 can represent a stage where maturity has started and seeds start to harden in less than 40% of the hemp plants. In some embodiments hemp plant growth stage 2203 can represent a stage where maturity has started and seeds start to harden in less than 45% of the hemp plants. In some embodiments hemp plant growth stage 2203 can represent a stage where maturity has started and seeds start to harden in less than 50% of the hemp plants.

In one embodiment, hemp plant growth stage 2203 represents a stage where maturity has started and seeds start to harden in less than 50% of the hemp plants.

In some embodiments, hemp plant growth stage 2204 can represent a hemp plant where at least 50% of the seeds are mature seeds. In some embodiments hemp plant growth stage 2204 can represent a hemp plant where at least 55% of the seeds are mature seeds. In some embodiments hemp plant growth stage 2204 can represent a hemp plant where at least 60% of the seeds are mature seeds. In some embodiments hemp plant growth stage 2204 can represent a hemp plant where at least 65% of the seeds are mature seeds. In some embodiments hemp plant growth stage 2204 can represent a hemp plant where at least 70% of the seeds are mature seeds. In some embodiments hemp plant growth stage 2204 can represent a hemp plant where at least 75% of the seeds are mature seeds. In some embodiments hemp plant growth stage 2204 can represent a hemp plant where at least 80% of the seeds are mature seeds. In some embodiments hemp plant growth stage 2204 can represent a hemp plant where at least 90% of the seeds are mature seeds. In some embodiments hemp plant growth stage 2204 can represent a hemp plant where less than 95% of the seeds are mature seeds.

In one embodiment, hemp plant growth stage 2004 represents a stage where between 50% and 95% of the seeds of the hemp plant are mature seeds.

In some embodiments, hemp plant growth stage 2205 can represent the end stage of seed maturity where at least 95% of the seeds are mature seeds or shattered seeds. In some embodiments, hemp plant growth stage 2205 can represent the end stage of seed maturity where at least 96% of the seeds are mature seeds or shattered seeds. In some embodiments, hemp plant growth stage 2205 can represent the end stage of seed maturity where at least 97% of the seeds are mature seeds or shattered seeds. In some embodiments, hemp plant growth stage 2205 can represent the end stage of seed maturity where at least 98% of the seeds are mature seeds or shattered seeds. In some embodiments, hemp plant growth stage 2205 can represent the end stage of seed maturity where at least 99% of the seeds are mature seeds or shattered seeds. In some embodiments, hemp plant growth stage 2205 can represent the end stage of seed maturity where 100% of the seeds are mature seeds or shattered seeds.

In some embodiments the integrity of the hemp plant biomass and the seeds material is substantially disrupted as a result of the treatment. As used herein the term “substantially” means more than 50% of the integrity of the treated matter such as for instance, hemp plant, hemp plant biomass, seeds material or hemp plant seeds material.

In some embodiments, the method for preparing the cannabinoid containing composition comprises at least one of a strain of hemp plant selected from a group consisting of a Cannabis indica strain, a Cannabis sativa, a hybrid strain, a low-cannabinoid strain, a Cannabis sativa strain Finola.

In some embodiments, the method for preparing the cannabinoid containing composition comprises the hemp plant Cannabis sativa strain Finola.

In some embodiments, the method for preparing the cannabinoid containing composition comprises hemp plant biomass and hemp plant seeds material, where the hemp plant biomass is derived from one or more hemp plants. In some embodiments, the method for preparing the cannabinoid containing composition comprises hemp plant biomass and hemp plant seeds material, where the hemp plant seeds material is derived from one or more hemp plants. In some embodiments the plants from which the hemp plant biomass is obtained is different from the plants from which the hemp plant seeds are obtained.

In some embodiments, the method for preparing the cannabinoid containing composition comprises hemp plant biomass and hemp plant seeds material where the hemp plant biomass and the hemp plant seeds material are derived from the same hemp plant.

In some embodiments, the method for preparing the cannabinoid containing composition comprises a composition with predetermined ratio of hemp plant biomass and seeds material, where the predetermined ratio is about 75% by weight of seeds material to about 25% by weight of hemp plant biomass. In some embodiments, the method for preparing the cannabinoid composition comprises a composition with predetermined ratio of hemp plant biomass and seeds material, where the predetermined ratio is about 2% by weight of seeds material to about 98% by weight of hemp plant biomass.

On some embodiment the method for preparing the cannabinoid containing composition further comprises an ingredient such as a flavour enhancing ingredient, off taste masking ingredient, flavour masking ingredient, off flavour masking ingredient, taste modulation ingredient or flavour modulation ingredient.

In some embodiment the method for preparing the cannabinoid containing composition further comprises an ingredient where the ingredient is at least one selected from the group of tea leaves, Lamiaceae species (including peppermint and spearmint), Verbascum species, Cinnamomum species, Elettatia cardamomum, plants of the Aquilaria genus, yarrow flower, Salvia species, Angelica species, catnip plants, lavender (Lavandula angustifolia), Taraxacum species, linden tree flowers, lemon verbena (Aloysia citrodora), gotu kola (Centella asiatica), Leonotis species, blue lotus (Nymphaea caerulea), kratom, herbal non-tobacco, mugwort, coltsfoot leaf, Heimia salicifolia, St. John's wort, Melissa officinalis, skullcap, yerba lenna yesca, Capillaris Herba, Calea zacatechichi, Leonurus sibericus, damiana, Withania somnifera, Mucuna pruriens, Celastrus paniculatus, Emblica officinalis, Terminalia chebula, Terminalia bellerica, Solanum xanthocarpum, Glycyrrhiza glabra, Ocimum sanctum, Zingiberaceae family and Zingiber officinale, a'hai, Commiphora mukul, Boswellia serrata, Vitex negundo, Bacopa monnieri, Cyperus rotundus, Myristica fragrans, Valeriana Nardostachys jatamansi, Mimosa hostilis, Avena sativa, kanna, Lactuca virosa, Cornus, pipsissewa (Chimaphila umbellata), pyrola, kinnikinnik, camomile, manzanita, Arctostaphylos species, madrone, Arbutus menziesii, Rubus species, scotch broom, calamus, Crocus sativus, Santalum album, Acacia confusa, Passifioraceae species, Echinacea purpurea and milk thistle (Silybum marianum).

In some embodiments the method for preparing a cannabinoid containing composition comprises a composition containing less than 30%, 29%, 28%, 27%, 26%, 25%, 20%, 15%, 10%, 9%, 8%, 7%, 6%, 5%, 4%, 3%, 2%, 1%, 0.5%, 0.25%, 0.2%, 0.15%, 0.1%, 0.05% tetrahydrocannabinol (THC).

In some embodiments the method for preparing a cannabinoid containing composition comprises a composition containing less than containing less than 0.2% tetrahydrocannabinol (THC).

In some embodiments the methods for preparing a cannabinoid containing composition comprises forming a cannabinoid product.

In some embodiments the cannabinoid product is loose tea.

In some embodiments the cannabinoid product is a tea bag.

Disclosed herein is also a use of a cannabinoid containing composition prepared according to the methods described here, for making a water-based infusion.

Disclosed herein is also a use of a cannabinoid product, the product comprising the cannabinoid composition prepared according to the methods described here, for making a water-based infusion.

Disclosed herein is also a water-based infusion obtained following use of the cannabinoid product comprising the cannabinoid composition prepared according to the methods described here.

### BRIEF DESCRIPTION OF THE DRAWINGS

FIG. 1 Depicts a graph comparing the release of cannabinoid in a water-based infusion from a cannabinoid containing composition comprising predetermined ratios of hemp plant biomass and seeds material.

### DETAILED DESCRIPTION

Throughout this disclosure, various scientific publications, patents and published patent specifications are referenced by an identifying citation. The disclosures of these publications, patents and published patent specifications are hereby incorporated by reference into the present disclosure to more fully describe the state of the art to which this disclosure pertains.

As used herein, certain terms may have the following defined meanings.

As used in the specification and claims, the singular form “a,” “an” and “the” include singular and plural references unless the context clearly dictates otherwise. For example, the term “a hemp plant” includes a single hemp plant, as well as a plurality of hemp plants or varieties, including mixtures thereof.

All numbers or numerals as used herein that indicate amounts, ratios of materials, physical properties of materials, and/or use are to be understood as modified or qualified by the term “about,” except as otherwise explicitly indicated.

As used herein, the term “about” includes the recited number or number and +/−10% from the recited numeral or number. By way of non-limiting example, the term “about ten (10)” would encompass nine (9) to eleven (11) or 9-11.

As used herein, the term “hemp plant biomass” means hemp buds, hemp flowers, hemp leaves, hemp fiber or hemp flowers removed or harvested from the hemp plant stalk. By way of example the hemp plant biomass may be hemp fiber biomass, hemp flower biomass, hemp bud biomass, or hemp leaves biomass. In some embodiments the hemp plant biomass comprises hemp fiber biomass. In some embodiments the hemp plant biomass comprises hemp flower biomass. In some embodiments the hemp plant biomass comprises hemp bud biomass. In some embodiments the hemp plant biomass comprises hemp leaves biomass. In some embodiments the hemp plant biomass comprises a mixture of hemp flower biomass, hemp bud biomass, hemp fiber biomass and hemp leaves biomass. In some embodiments the hemp plant biomass comprises hemp plant biomass from any one or more of growth stages selected from the group of 2202, 2203, 2204 and 2205.

As used herein, the term “seeds material” means any edible seeds such as for example cereals, pseudocereals, legumes, nuts or other seeds. In some embodiments the plant from which seeds material is derived can be selected from the group consisting of sunflower, pumpkin, jackfruit, cempedak, cocoa, coffee, durian, fox nut, hemp, lotus, poppy, pomegranate, watermelon, stone pine, single-leaf pinyon, Mexican pinuon, Korean pine, chingoza pine, pine nuts, monkey-puzzle, juniper, gnetum, ginkgo and cycads. By way of example, the seeds may be immature seeds, mature seeds, hard seed or shattered seeds. The fat or lipid molecular such as fatty acids, which can be found in seeds are for example Omega-6 and Omega-3 fatty acids, notably linoleic acid and alpha-linolenic acid. In some embodiments, the seed material contains fatty acids selected from the group consisting of Omega fatty acids such as Omega-6 and Omega-3, linoleic acid, alpha-linolenic, oleic acid and other mono-unsaturated, polyunsaturated and saturated fatty acids.

In some embodiments the seeds material is derived from a sunflower. In some embodiments the seeds material comprises sunflower seeds material. In some embodiments the sunflower seeds material contains over 30% lipid. In some embodiments the sunflower seeds material contains over 31% lipid. In some embodiments the sunflower seeds material contains over 32% lipid. In some embodiments the sunflower seeds material contains over 33% lipid. In some embodiments the sunflower seeds material contains over 34%, 35%, 36%, 37%, 38%, 39%, 40% lipid.

In some embodiments the seeds material is derived from a pumpkin. In some embodiments the seeds material comprises pumpkin seeds material. In some embodiments the pumpkin seeds material contains over 30% lipid. In some embodiments the pumpkin seeds material contains over 31% lipid. In some embodiments the pumpkin seeds material contains over 32% lipid. In some embodiments the pumpkin seeds material contains over 33% lipid. In some embodiments the pumpkin seeds material contains over 34%, 35%, 36%, 37%, 38%, 39%, 40% lipid.

In some embodiment, the growth stage of the plant from which the seeds material is derived or the time of harvesting of the plant may not affect the cannabinoid containing composition and any subsequent uses of the cannabinoid containing composition. In some embodiments, the growth stage of the plant from which the seeds material is derived or the time of harvesting of the plant may affect the cannabinoid containing composition and any subsequent uses of the cannabinoid containing composition.

In some embodiments the seeds material is derived from a hemp plant. In some embodiments the seeds material is a hemp plant seeds material.

As used herein, the term “hemp plant seeds material” means bracts, grains or seeds from a hemp plant. By way of example the bracts, grains or seeds may be from any one or more of growth stages selected from the group of 2202, 2203, 2204 and 2205. By way of example, the hemp seeds may be immature seeds, mature seeds, hard seed or shattered seeds. In some embodiments the hemp plant seeds material comprises hemp bracts. In some embodiment the hemp plant seeds material comprises hemp grains. In some embodiments the hemp plant seeds material comprises hemp seeds. In some embodiments the hemp plant seeds material comprises a mixture of hemp bracts, hemp grains or hemp seeds. The fat or lipid molecular such as fatty acids, which can be found in hemp seeds are for example Omega-6 and Omega-3 fatty acids, linoleic acid and alpha-linolenic acid. In some embodiments, the hemp plant seed material contains fatty acids selected from the group consisting of Omega-6 and Omega-3 fatty acids, linoleic acid and alpha-linolenic acid. In some embodiments the hemp plant seeds material contains over 30% lipid. In some embodiments the hemp plant seeds material contains over 31% lipid. In some embodiments the hemp plant seeds material contains over 32% lipid. In some embodiments the hemp plant seeds material contains over 33% lipid. In some embodiments the hemp plant seeds material contains over 34%, 35%, 36%, 37%, 38%, 39%, 40% lipid.

As used herein the term “hemp plant variety” is interchangeable with the terms “hemp plant strain” or “hemp plant cultivar”.

As used herein the term “hemp plant” means any hemp variety, hemp strain or hemp cultivar as planted, grown, harvested at the appropriate growth stage as described here, from which hemp plant biomass or in some embodiment from which the seeds material may be obtained. In some embodiments the growth stage of the plant may be from any one of growth stages selected from the group of 2202, 2203, 2204 and 2205. In some embodiments the hemp plants are harvested by mechanical means. In some embodiments the hemp plants are harvested by hand. In some embodiments the hemp plants are harvested by hand in order to try and protect the cannabinoid profile.

Disclosed herein is a method for preparing a cannabinoid containing composition which is easy to use and has the desired biological activities.

Highly unsaturated fatty acids are more susceptible to oxidation because of the increased number of double bonded carbon atoms. Therefore, delicate seeds such as hemp seeds, must be treated with care. Rancidity comes easily to hemp, which gives many hemp comprising products their notorious “off” or “bitter” aftertaste.

It was unexpectedly and surprisingly observed that it is possible to obtain cannabinoid containing compositions which are easy to use by overcoming at least some of the problems associated with cannabinoids such as lack of water solubility. The methods described herein also eliminate the use of solvents to extract cannabinoids using complex oil emulsions to increase solubility and bioavailability as well as reduce the cost associated with removal of solvents and “bitter” taste. A method is provided to prepare a cannabinoid containing composition from which composition the inherently hydrophobic cannabinoids are rendered water soluble and bioavailable without the use of any solvents. Moreover, the method for preparing a cannabinoid containing composition substantially reduces or completely eliminates any possible “off” or “bitter” taste.

A high complex lipid content from the seeds material seems to allow the use of the hemp plant biomass as a water-based product which may be extracted in hot water, room temperature water or even cold water as a water drink or water-based infusion. It is expected that this is achieved because the cannabinoids from the plant biomass bind to the complex lipid molecules produced by the high quantity of seeds material so as to enable extraction in water, which would otherwise not be possible.

According to one aspect, there is provided a method for preparing a cannabinoid containing composition comprising the steps of providing hemp plant biomass and hemp plant seeds material; mixing the hemp plant biomass and the hemp plant seeds material to a predetermined ratio of hemp plant biomass and hemp plant seeds material.

As used herein the term “predetermined ratio” refers to hemp plant seeds material relative to hemp plant biomass by weight. By way of example, predetermined ratio is about 75% by weight of seeds material to about 25% by weight of hemp plant biomass, about 2% by weight of seeds material to about 98% by weight of hemp plant biomass, about 5% by weight of seeds material to about 95% by weight of hemp plant biomass, about 10% by weights seeds material to about 90% by weight of hemp plant biomass, about 15% by weight of seeds material to about 85% by weight of hemp plant biomass, about 20% by weight of seeds material to about 80% by weight of hemp plant biomass, about 25% by weight of seeds material to about 75% by weight of hemp plant biomass, about 30% by weight of seeds material to about 70% by weight of hemp plant biomass, about 35% by weight of seeds material to about 65% by weight of hemp plant biomass, about 40% by weight of seeds material to about 60% by weight of hemp plant biomass, about 45% by weight seeds material to about 55% by weight of hemp plant biomass, about 50% by weight of seeds material to 50% by weight of hemp plant biomass, about 55% by weight of seeds biomass to about 45% by weight of hemp plant biomass, about 60% by weight of seeds material to about 40% by weight of hemp plant biomass, about 65% by weight of seeds material to about 35% by weights of hemp plant biomass, about 70% by weight of seeds material to about 30% by weight of hemp plant biomass, about 75% of seeds material to about 25% by weight of hemp plants biomass, about 80% by weight of seeds material to about 20% by weight of hemp plant biomass, about 85% by weight of seeds material to about 15% by weight of hemp plant biomass, about 90% by weight of seeds material to about 10% by weight of hemp plant biomass.

In some embodiments, the method for preparing the cannabinoid containing composition comprises a composition with predetermined ratio of hemp plant biomass and seeds material, where the predetermined ratio is about 75% by weight of seeds material to about 25% by weight of hemp plant biomass. In some embodiments, the method for preparing the cannabinoid composition comprises a composition with predetermined ratio of hemp plant biomass and seeds material, where the predetermined ratio is about 2% by weight of seeds material to about 98% by weight of hemp plant biomass.

In some embodiments, the method for preparing the cannabinoid containing composition comprises a composition with predetermined ratio of hemp plant biomass and seeds material, where the predetermined ratio is about 5% by weight of seeds material to about 95% by weight of hemp plant biomass.

In some embodiments, the method for preparing the cannabinoid containing composition comprises a composition with predetermined ratio of hemp plant biomass and seeds material, where the predetermined ratio is about 10% by weights seeds material to about 90% by weight of hemp plant biomass.

In some embodiments, the method for preparing the cannabinoid containing composition comprises a composition with predetermined ratio of hemp plant biomass and seeds material, where the predetermined ratio is about 15% by weight of seeds material to about 85% by weight of hemp plant biomass.

In some embodiments, the method for preparing the cannabinoid containing composition comprises a composition with predetermined ratio of hemp plant biomass and seeds material, where the predetermined ratio is about 20% by weight of seeds material to about 80% by weight of hemp plant biomass.

In some embodiments, the method for preparing the cannabinoid containing composition comprises a composition with predetermined ratio of hemp plant biomass and seeds material, where the predetermined ratio is about 25% by weight of seeds material to about 75% by weight of hemp plant biomass.

In some embodiments, the method for preparing the cannabinoid containing composition comprises a composition with predetermined ratio of hemp plant biomass and seeds material, where the predetermined ratio is about 30% by weight of seeds material to about 70% by weight of hemp plant biomass.

In some embodiments, the method for preparing the cannabinoid containing composition comprises a composition with predetermined ratio of hemp plant biomass and seeds material, where the predetermined ratio is about 35% by weight of seeds material to about 65% by weight of hemp plant biomass.

In some embodiments, the method for preparing the cannabinoid containing composition comprises a composition with predetermined ratio of hemp plant biomass and seeds material, where the predetermined ratio is about 40% by weight of seeds material to about 60% by weight of hemp plant biomass.

In some embodiments, the method for preparing the cannabinoid containing composition comprises a composition with predetermined ratio of hemp plant biomass and seeds material, where the predetermined ratio is about 45% by weight seeds material to about 55% by weight of hemp plant biomass.

In some embodiments, the method for preparing the cannabinoid containing composition comprises a composition with predetermined ratio of hemp plant biomass and seeds material, where the predetermined ratio is about 50% by weight of seeds material to 50% by weight of hemp plant biomass.

In some embodiments, the method for preparing the cannabinoid containing composition comprises a composition with predetermined ratio of hemp plant biomass and seeds material, where the predetermined ratio is about 55% by weight of seeds biomass to about 45% by weight of hemp plant biomass.

In some embodiments, the method for preparing the cannabinoid containing composition comprises a composition with predetermined ratio of hemp plant biomass and seeds material, where the predetermined ratio is about 60% by weight of seeds material to about 40% by weight of hemp plant biomass.

In some embodiments, the method for preparing the cannabinoid containing composition comprises a composition with predetermined ratio of hemp plant biomass and seeds material, where the predetermined ratio is about 65% by weight of seeds material to about 35% by weights of hemp plant biomass.

In some embodiments, the method for preparing the cannabinoid containing composition comprises a composition with predetermined ratio of hemp plant biomass and seeds material, where the predetermined ratio is about 70% by weight of seeds material to about 30% by weight of hemp plant biomass.

In some embodiments, the method for preparing the cannabinoid containing composition comprises a composition with predetermined ratio of hemp plant biomass and seeds material, where the predetermined ratio is about 75% of seeds material to about 25% by weight of hemp plants biomass.

In some embodiments, the method for preparing the cannabinoid containing composition comprises a composition with predetermined ratio of hemp plant biomass and seeds material, where the predetermined ratio is about 80% by weight of seeds material to about 20% by weight of hemp plant biomass.

In some embodiments, the method for preparing the cannabinoid containing composition comprises a composition with predetermined ratio of hemp plant biomass and seeds material, where the predetermined ratio is about 85% by weight of seeds material to about 15% by weight of hemp plant biomass.

In some embodiments, the method for preparing the cannabinoid containing composition comprises a composition with predetermined ratio of hemp plant biomass and seeds material, where the predetermined ratio is about 90% by weight of seeds material to about 10% by weight of hemp plant biomass.

Cannabinoids or phytocannabinoids are found in hemp plants in the form of their carboxyl derivatives, the cannabinoid carboxylic acids, from which the so-called “neutral cannabinoids” are derived by decarboxylation, i.e. CO2 elimination. Thus, for example, cannabidiol (CBD) is formed by the decarboxylation of cannabidiolic acid (CBDA). CBD can be found in the hemp plant both in its acidic form (CBDA) and in the decarboxylated version (CBD).

As used herein the term “cannabinoids” or “phytocannabinoids” refer to psychoactive and non-psychoactive compounds found in the dioecious plants of the genus Cannabis. By way of example, the primary psychoactive compound is delta-9 tetrahydro-cannabinol, commonly known as THC, while the primary non-psychoactive compounds are cannabidiol (CBD) and its precursor cannabidiolic acid (CBDA).

As used herein the term “cannabinoid containing composition” is used interchangeably with the term “CBD containing composition” which means a collection of parts, constituents or fragments derived from a plant such as hemp plant biomass, leaves, flowers, bracts, grains and seeds material. In some embodiments the cannabinoid containing composition is composed of a dry collection of parts, constituents or fragments derived from a plant such as hemp plant biomass, leaves, flowers, bracts, grains and seeds material.

In some embodiments, the method for preparing the cannabinoid containing composition comprises a composition containing different cannabinoid compounds.

In some embodiments, the method for preparing the cannabinoid containing composition comprises a composition containing psychoactive cannabinoid compounds and non-psychoactive cannabinoid compounds.

In some embodiments, the method for preparing the cannabinoid containing composition comprises a composition containing less than 30% tetrahydrocannabinol (THC). In some embodiments, the method for preparing the cannabinoid containing composition comprises a composition containing less than 29% THC. In some embodiments, the method for preparing the cannabinoid containing composition comprises a composition containing less than 28% THC. In some embodiments, the method for preparing the cannabinoid containing composition comprises a composition containing less than 27% THC. In some embodiments, the method for preparing the cannabinoid containing composition comprises a composition containing less than 25% THC. In some embodiments, the method for preparing the cannabinoid containing composition comprises a composition containing less than 20% THC. In some embodiments, the method for preparing the cannabinoid containing composition comprises a composition containing less than 15% THC. In some embodiments, the method for preparing the cannabinoid containing composition comprises a composition containing less than 10% THC. In some embodiments, the method for preparing the cannabinoid containing composition comprises a composition containing less than 5% THC. In some embodiments, the method for preparing the cannabinoid containing composition comprises a composition containing less than 2% THC. In some embodiments, the method for preparing the cannabinoid containing composition comprises a composition containing less than 1% THC. In some embodiments the method for preparing the cannabinoid containing composition comprises a composition containing less than 0.5 THC. In some embodiments the method for preparing the cannabinoid containing composition comprises a composition containing less than 0.25% THC. In some embodiments the method for preparing the cannabinoid containing composition comprises a composition containing less than 0.2% THC. In some preferred embodiments the method for preparing the cannabinoid containing composition comprises a composition containing less than 0.15% THC. In some preferred embodiments the method for preparing the cannabinoid containing composition comprises a composition containing less than 0.1% THC. In some preferred embodiments the method for preparing the cannabinoid containing composition comprises a composition containing less than 0.05% THC.

In some embodiments, the method for preparing the cannabinoid containing composition comprises a composition containing non-phychoactive cannabinoids.

The greater or lesser presence of one or the other form of the cannabinoid in the hemp plant may depend on the plant growing conditions and therefore on environmental parameters, and on the conditions used for the subsequent stage of growth when harvesting, processing and storage phases.

Careful selection of the soil before commencing to sow hemp affects the quality of the plants and or any part or fragments thereof such as hemp plant biomass, flowers, bracts, grains or seeds. It is contemplated within the present invention that appropriate soil constituent tests are performed to determine for example pH, levels of organic matter, and macro- and micro-elements. In some embodiments, the hemp plant which is used in the methods of the present invention is grown on soil which is tested for levels of pH, organic matter and phosphorus, potassium, sulfur and calcium.

In some embodiments, the hemp plant which is used in the method for preparing the cannabinoid containing composition is grown on soil with pH between 6.3 and 7.8. In some embodiments, the hemp plant which is used in the method for preparing the cannabinoid containing composition is grown on soil with pH 7.0.

In some embodiments, the hemp plant which is used in the method for preparing the cannabinoid containing composition is grown on soil which contains at least 3.5% organic matter. In some embodiments the hemp plant which is used in the method for preparing the cannabinoid containing composition is grown on soil which contains at least 4% organic matter. In some embodiments the hemp plant which is used in the method for preparing the cannabinoid containing composition is grown on soil which contains at least 4.5% organic matter. In some embodiments the hemp plant which is used in the method for preparing the cannabinoid containing composition is grown on soil which contains at least 5% organic matter. In some embodiments the hemp plant which is used in the method for preparing the cannabinoid containing composition is grown on soil which contains at least 5.5% organic matter. In some embodiments the hemp plant which is used in the method for preparing the cannabinoid containing composition is grown on soil which contains at least 6% organic matter. In some embodiments the hemp plant which is used in the method for preparing the cannabinoid containing composition is grown on soil which contains at least 6.5% organic matter. In some embodiments the hemp plant which is used in the method for preparing the cannabinoid containing composition is grown on soil which contains at least 8% organic matter.

In some embodiments, the hemp plant which is used in the method for preparing the cannabinoid containing composition is grown on soil which contains at least 40 ppm of phosphorous. In some embodiments the hemp plant which is used in the method for preparing the cannabinoid containing composition is grown on soil which contains at least 50 ppm of phosphorous. In some embodiments, the hemp plant which is used in the method for preparing the cannabinoid containing composition is grown on soil which contains at least 60 ppm of phosphorous. In some embodiments, the hemp plant which is used in the method for preparing the cannabinoid containing composition is grown on soil which contains at least 80 ppm of phosphorous. In some embodiments, the hemp plant which is used in the method for preparing the cannabinoid containing composition is grown on soil which contains at least 100 ppm of phosphorous. In some embodiments, the hemp plant which is used in the method for preparing the cannabinoid containing composition is grown on soil which contains 100 ppm of phosphorous or more.

In some embodiments, the hemp plant which is used in the method for preparing the cannabinoid containing composition is grown on soil which contains at least 250 ppm of potassium. In some embodiments the hemp plant which is used in the method for preparing the cannabinoid containing composition is grown on soil which contains at least 300 ppm of potassium. In some embodiments the hemp plant which is used in the method for preparing the cannabinoid containing composition is grown on soil which contains at least 350 ppm of potassium. In some embodiments the hemp plant which is used in the method for preparing the cannabinoid containing composition is grown on soil which contains at least 400 ppm of potassium. In some embodiments the hemp plant which is used in the method for preparing the cannabinoid containing composition is grown on soil which contains at least 450 ppm of potassium. In some embodiments the hemp plant which is used in the method for preparing the cannabinoid containing composition is grown on soil which contains at least 500 ppm of potassium. In some embodiments, the hemp plant which is used in the method for preparing the cannabinoid containing composition is grown on soil which contains 600 ppm of potassium or more.

In some embodiments, the hemp plant which is used in the method for preparing the CBD containing composition is grown on soil which contains at least 5000 ppm of sulfur. In some embodiments the hemp plant which is used in the method for preparing the cannabinoid containing composition is grown on soil which contains at least 5500 ppm of sulfur. In some embodiments the hemp plant which is used in the method for preparing the cannabinoid containing composition is grown on soil which contains at least 6000 ppm of sulfur. In some embodiments the hemp plant which is used in the method for preparing the cannabinoid containing composition is grown on soil which contains at least 6500 ppm of sulfur. In some embodiments the hemp plant which is used in the method for preparing the cannabinoid containing composition is grown on soil which contains at least 7000 ppm of sulfur. In some embodiments the hemp plant which is used in the method for preparing the cannabinoid containing composition is grown on soil which contains at least 7500 ppm of sulfur. In some embodiments the hemp plant which is used in the method for preparing the cannabinoid containing composition is grown on soil which contains at least 8000 ppm of sulfur. In some embodiments the hemp plant which is used in the method for preparing the cannabinoid containing composition is grown on soil which contains 10000 ppm of sulfur or more.

In some embodiments, the hemp plant which is used in the method for preparing the cannabinoid containing composition is grown on soil which contains less than 6000 ppm of calcium. In some embodiments the hemp plant which is used in the method for preparing the cannabinoid containing composition is grown on soil which contains less than 5500 ppm of calcium. In some embodiments the hemp plant which is used in the method for preparing the cannabinoid containing composition is grown on soil which contains less than 5000 ppm of calcium. In some embodiments the hemp plant which is used in the method for preparing the cannabinoid containing composition is grown on soil which contains less than 4500 ppm of calcium. In some embodiments the hemp plant which is used in the method for preparing the cannabinoid containing composition is grown on soil which contains less than 4000 ppm of calcium. In some embodiments the hemp plant which is used in the method for preparing the cannabinoid containing composition is grown on soil which contains less than 3500 ppm of calcium or less.

Without wishing to be bound by theory, it is contemplated that the water or humidity content in the hemp plant from which the hemp plant biomass and the hemp plant seeds material are obtained can influence the cannabinoid containing composition and any subsequent uses of the cannabinoid containing composition.

In some embodiments the entire hemp plant is dried after harvest.

In some embodiments the hemp plant biomass may be exposed to additional drying.

In some embodiments the hemp plant seeds material can be exposed to additional drying.

Agricultural or horticultural crops, spices, medicinal and aromatic plants such as hemp plants which belong to the Cannabis genus can be air-dried in an open or closed environment or direct sun. Other forms or drying or additional forms of drying include for example hot-air oven drying, solar drier drying, cross-flow drying, through-flow drying, vacuum shelf drying and other techniques can be employed for drying. Microwave drying, freeze drying, infrared or inert gas drying and combo drying techniques have also been used.

As used herein the term “drying” means a mass transfer process consisting of the removal of fluid or moisture by evaporation from a hemp plant or any part, constituent or fragments thereof such as for example hemp plant biomass, flowers, bracts, grains or seeds material. Different methods of determining the moisture content (MC) would be known to those of skill in the art. By way of example, the earliest and still most widely used technique for measuring moisture loss or moisture content is weight loss on drying. In this technique, the plant weight at the start is recorded. After drying the plant weight is recorded too. The difference in these two weights is considered to represent the moisture lost or moisture content (MC) in the plant. The technique is often referred to as Loss-on Drying or LOD.

In some embodiments, hemp plant biomass and the seeds material are subjected to drying. In some embodiments, hemp plant biomass and the seeds material are air-dried in an open or closed environment or direct sun. In some embodiments, hemp plant biomass and the seeds material are hot-air oven dried. In some embodiments, hemp plant biomass and the seeds material are dried in a solar drier. In some embodiments, hemp plant biomass and the seeds material are dried in a cross-flow drier. In some embodiments, hemp plant biomass and the seeds material are dried in through-flow drier. In some embodiments, hemp plant biomass and the seeds material are dried in a vacuum shelf drier.

In some embodiments, the method for preparing the CBD containing composition comprises hemp plant biomass which has less than about 20% moisture content (MC). In some embodiments the method for preparing the CBD containing composition comprises hemp plant biomass which less than about 18% MC. In some embodiments the method for preparing the CBD containing composition comprises hemp plant biomass which has less than about 16% MC. In some embodiments the method for preparing the CBD containing composition comprises hemp plant biomass which has less than about 14% MC. In some embodiments the method for preparing the CBD containing composition comprises hemp plant biomass which has less than about 12% MC. In some embodiments the method for preparing the CBD containing composition comprises hemp plant biomass which has less than about 10% MC. In some embodiments the method for preparing the CBD containing composition comprises hemp plant biomass which has less than about 8% MC. In some embodiments the method for preparing the CBD containing composition comprises hemp plant biomass which has less than about 6% MC. In some embodiments the method for preparing the CBD containing composition comprises hemp plant biomass which has less than about 4% MC. In some embodiments the method for preparing the CBD containing composition comprises hemp plant biomass which has less than about 2% MC.

In an embodiment, the method for preparing the cannabinoid containing composition comprises hemp plant biomass which has about 12% MC. In one embodiment the method for preparing the cannabinoid composition comprises hemp plant biomass which has 12% MC.

In some embodiments, the method for preparing the cannabinoid containing composition comprises hemp plant seeds material. In some embodiments the method for preparing the cannabinoid containing composition comprises hemp plant seeds material which has less than about 20% moisture content (MC). In some embodiments the method for preparing the cannabinoid containing composition comprises hemp plant seeds material which has less than about 18% MC. In some embodiments the method for preparing the cannabinoid containing composition comprises hemp plant seeds material which has less than about 16% MC. In some embodiments the method for preparing the cannabinoid containing composition comprises hemp plant seeds material which has less than about 14% MC. In some embodiments the method for preparing the cannabinoid containing composition comprises hemp plant seeds material which has less than about 12% MC. In some embodiments the method for preparing the cannabinoid containing composition comprises hemp plant seeds material which has less than about 10% MC. In some embodiments the method for preparing the cannabinoid containing composition comprises hemp plant seeds material which has less than about 8% MC. In some embodiments the method for preparing the cannabinoid containing composition comprises hemp plant seeds material which has less than about 6% MC. In some embodiments the method for preparing the cannabinoid containing composition comprises hemp plant seeds material which has less than about 4% MC. In some embodiments the method for preparing the cannabinoid containing composition comprises hemp plant seeds material which has less than about 2% MC. In some embodiments the method for preparing the cannabinoid containing composition comprises hemp plant seeds material which has less than about 1% MC.

In an embodiment, the method for preparing the cannabinoid containing composition comprises hemp plant seeds material which has about 12% MC. In one embodiment, the method for preparing the cannabinoid containing composition comprises hemp plant seeds material which has 12% MC.

There are many different approached which are used in the agriculture industry to assess and determine the growth phase or development stage of hemp crops. For the purposes of the methods described herein which are used to prepare cannabinoid containing compositions, reference will be made to one such approach. It is contemplated that the growth stage of the hemp plant or the time of harvesting of the hemp plant, characterised as a dioecious plant (Zadoks et al., (1974) Weed Research 14: 415-421; Mediavilla et al., 1998 A decimal Code for Growth stages of Fibre hemp (Cannnabic sativa L.) Journal of the International Hemp Association 5(2):65, 68-74), from which the hemp plant biomass or the hemp plant seeds material are obtained can affect the CBD containing composition and any subsequent uses of the CBD containing composition.

According to some embodiments, the hemp plant biomass is obtained from hemp plants which are at any one or more of the growth stages selected from the group of 2202, 2203, 2204 and 2205 (Zadoks et al., 1974; Mediavilla et al., 1998).

Accordingly, in some embodiments, the hemp plant seeds material comprises material obtained from any one or more of the growth stages selected from the group of 2202, 2203, 2204 and 2205.

In some embodiments, hemp plant growth stage 2202 can represent a hemp plant where at least 50% of the hemp plant bracts or flowers are formed. In some embodiments hemp plant growth stage 2202 can represent a hemp plant where at least 55% of the hemp plant bracts or flowers are formed. In some embodiments hemp plant growth stage 2202 can represent a hemp plant where at least 60% of the hemp plant bracts or flowers are formed. In some embodiments hemp plant growth stage 2202 can represent a hemp plant where at least 65% of the hemp plant bracts or flowers are formed. In some embodiments hemp plant growth stage 2202 can represent a hemp plant where at least 70% of the hemp plant bracts or flowers are formed. In some embodiments hemp plant growth stage 2202 can represent a hemp plant where at least 75% of the hemp plant bracts or flowers are formed. In some embodiments hemp plant growth stage 2202 can represent a hemp plant where at least 80% of the hemp plant bracts or flowers are formed. In some embodiments hemp plant growth stage 2202 can represent a hemp plant where at least 85% of the hemp plant bracts or flowers are formed. In some embodiments hemp plant growth stage 2202 can represent a hemp plant where at least 90% of the hemp plant bracts or flowers are formed. In some embodiments hemp plant growth stage 2202 can represent a hemp plant where at least 95% of the hemp plant bracts or flowers are formed. In some embodiments hemp plant growth stage 2202 can represent a hemp plant where more than 95% of the hemp plant bracts or flowers are formed.

In one embodiment, hemp plant growth stage 2202 represents a hemp plant where at least 50% of the hemp plant bracts or flowers are formed.

In some embodiments, hemp plant growth stage 2203 can represent a stage where hemp plant maturity has started and seeds start to harden. In some embodiments hemp plant growth stage 2203 can represent a stage where maturity has started and seeds start to harden in less than 5% of the hemp plants. In some embodiments hemp plant growth stage 2203 can represent a stage where maturity has started and seeds start to harden in less than 10% of the hemp plants. In some embodiments hemp plant growth stage 2203 can represent a stage where maturity has started and seeds start to harden in less than 15% of the hemp plants. In some embodiments hemp plant growth stage 2203 can represent a stage where maturity has started and seeds start to harden in less than 20% of the hemp plants. In some embodiments hemp plant growth stage 2203 can represent a stage where maturity has started and seeds start to harden in less than 25% of the hemp plants. In some embodiments hemp plant growth stage 2203 can represent a stage where maturity has started and seeds start to harden in less than 30% of the hemp plants. In some embodiments hemp plant growth stage 2203 can represent a stage where maturity has started and seeds start to harden in less than 35% of the hemp plants. In some embodiments hemp plant growth stage 2203 can represent a stage where maturity has started and seeds start to harden in less than 40% of the hemp plants. In some embodiments hemp plant growth stage 2203 can represent a stage where maturity has started and seeds start to harden in less than 45% of the hemp plants. In some embodiments hemp plant growth stage 2203 can represent a stage where maturity has started and seeds start to harden in less than 50% of the hemp plants.

In one embodiment, hemp plant growth stage 2203 represents a stage where maturity has started and seeds start to harden in less than 50% of the hemp plants.

In some embodiments, hemp plant growth stage 2204 can represent a hemp plant where at least 50% of the seeds are mature seeds. In some embodiments hemp plant growth stage 2204 can represent a hemp plant where at least 55% of the seeds are mature seeds. In some embodiments hemp plant growth stage 2204 can represent a hemp plant where at least 60% of the seeds are mature seeds. In some embodiments hemp plant growth stage 2204 can represent a hemp plant where at least 65% of the seeds are mature seeds. In some embodiments hemp plant growth stage 2204 can represent a hemp plant where at least 70% of the seeds are mature seeds. In some embodiments hemp plant growth stage 2204 can represent a hemp plant where at least 75% of the seeds are mature seeds. In some embodiments hemp plant growth stage 2204 can represent a hemp plant where at least 80% of the seeds are mature seeds. In some embodiments hemp plant growth stage 2204 can represent a hemp plant where at least 90% of the seeds are mature seeds. In some embodiments hemp plant growth stage 2204 can represent a hemp plant where less than 95% of the seeds are mature seeds.

In one embodiment, hemp plant growth stage 2004 represents a stage where between 50% and 95% of the seeds of the hemp plant are mature seeds.

In some embodiments, hemp plant growth stage 2205 can represent the end stage of seed maturity where at least 95% of the seeds are mature seeds or shattered seeds. In some embodiments, hemp plant growth stage 2205 can represent the end stage of seed maturity where at least 96% of the seeds are mature seeds or shattered seeds. In some embodiments, hemp plant growth stage 2205 can represent the end stage of seed maturity where at least 97% of the seeds are mature seeds or shattered seeds. In some embodiments, hemp plant growth stage 2205 can represent the end stage of seed maturity where at least 98% of the seeds are mature seeds or shattered seeds. In some embodiments, hemp plant growth stage 2205 can represent the end stage of seed maturity where at least 99% of the seeds are mature seeds or shattered seeds. In some embodiments, hemp plant growth stage 2205 can represent the end stage of seed maturity where 100% of the seeds are mature seeds or shattered seeds.

In some embodiments the method for preparing a cannabinoid composition according to the present invention comprises further treating the hemp plant biomass and the seeds material.

In some embodiments the hemp plant biomass and the seeds material are treated separately, sequentially or concomitantly.

In some embodiments the hemp plant biomass or the hemp plant seeds material are treated during harvesting of the hemp plants. In some embodiments the hemp plant biomass or the hemp plant seeds material are treated immediately after harvesting. In some embodiments the hemp plant biomass or the hemp plant seeds material are treated by physical agitation. In some embodiments the hemp plant biomass or the hemp plant seeds material are treated by the application of pressure. In some embodiments the hemp plant biomass or the hemp plant seeds material are treated with mechanical means. In some embodiments the hemp plant biomass or the hemp plant seeds material are treated with sonication. In some embodiments the hemp plant biomass or the hemp plant seeds material are treated with pneumatic pressure.

In some embodiments the hemp plant biomass or the hemp plant seeds material are treated before drying. In some embodiments the hemp plant biomass and the hemp plant seeds material are treated after drying.

In order to try and address some of the challenges of the conventional art when hemp is treated, the methods described herein may employ apparatus and techniques which utilize different types and forms of physical forces, such as for example pseudo forces, which are generated by an agitator such as rotating agitator, resulting in increased advection and chaotic mixing of the hemp plant e.g. hemp plant biomass and hemp plant seeds material. In some embodiments the agitator is made from resilient material. A resilient material has the ability to absorb energy when it is deformed elastically and release that energy upon release. Resilient materials which are suitable for making the agitator are for example rubber and plastics. In some embodiments the agitator is made from rubber.

In some embodiments, the hemp plant is placed into a feed hopper of an apparatus. In some embodiments the apparatus is supplemented with additional seeds material. In some embodiments the apparatus comprises an agitator such as a rotating agitator and a mesh or grate. In some embodiments, the mesh or the grate surrounds the rotating agitator. In some embodiments, the mesh or the grate which surrounds the rotating agitator forms a rotating chamber. In some embodiments, the mesh or the grate which surrounds the rotating agitator forms a plurality of rotating chambers. In some embodiments the mesh or grate has openings or holes of varying size, shape or diameter. In some embodiments, the hemp plant, while rotating in the chamber, is subjected to different forces e.g. physical forces as a result of contact or rubbing, of the agitator against the mesh or the grate. In some embodiments, the physical forces cause separation of the stalks from the plant. In some embodiments, the separation of the stalks leads to the formation of hemp plant biomass. In some embodiments, the separation of the stalks leads to the formation of hemp plant seeds material. In some embodiment, the separation of the stalks leads to the formation of a mixture of hemp plant biomass and hemp plant seeds material.

In some embodiments the forces such as physical forces create friction between the hemp plant and the mesh or the grate.

In some embodiments, the different forces such as physical forces applied on the hemp plant such as hemp plant biomass, against the mesh or grate result in activation of the cannabinoids.

In some embodiments, the different forces such as physical forces applied on the seeds material, against the mesh or grate results in activation of the lipid or fat molecules in the seeds material.

In some embodiments, the different forces such as physical forces applied on the seeds material such as hemp plant seeds material, against the mesh or grate results in activation of the lipid or fat molecules in the hemp plant seeds material.

In some embodiments the rotation of the agitator and/or the chamber is set to cycles of unidirectional acceleration-and-deceleration rotation.

Without wishing to be bound by theory, in a rotating environment where there is water content, Euler pseudo force (which is perpendicular to centrifugal or rotating pseudo force), may be used to generate vortical flow and provide uniform mixing within a microfluidic environments of the hemp plant biomass and/or hemp plant seeds material as rotating within the apparatus. Euler pseudo forces are inertial forces that are produced when within the microfluidic environments within the apparatus the experiences cycles of unidirectional acceleration-and-deceleration rotation. Thus, mixing is dependent on chamber geometry, acceleration/deceleration rate, and angular spin. In some embodiments the apparatus is subjected to cycles of unidirectional acceleration-and-deceleration rotation.

In some embodiments the openings or holes, of varying shape, size or diameter, in the mesh or the grate can be specifically chosen to produce a desired CBD composition.

In some embodiments the openings of the mesh or grate are square in shape.

In some embodiments the size of the square shape openings or holes is 1 mm. In some embodiments the size of the square shape openings or holes is 2 mm. In some embodiments the size of the square shape openings or holes is 3 mm. In some embodiments the size of the square shape openings or holes is 4 mm. In some embodiments the size of the square shape openings or holes is 5 mm. In some embodiments the size of the square shape openings or holes is 6 mm. In some embodiments the size of the square shape openings or holes is 7 mm. In some embodiments the size of the square shape openings or holes is 8 mm. In some embodiments the size of the square shape openings or holes is 9 mm. In some embodiments the size of the square shape openings or holes is 10 mm. In some embodiments the size of the square shape openings or holes is 11 mm. In some embodiments the size of the square shape openings or holes is 12 mm. In some embodiments the size of the square shape openings or holes is 13 mm. In some embodiments the size of the square shape openings or holes is 14 mm. In some embodiments the size of the square shape openings or holes is 15 mm. In some embodiments the size of the square shape openings or holes is 16 mm. In some embodiments the size of the square shape openings or holes is greater than 16 mm.

In some embodiments the openings or holes of the mesh or grate are circular in shape.

In some embodiments the diameter of the circular openings or holes is 1 mm. In some embodiments the diameter of the circular openings or holes is 2 mm. In some embodiments the diameter of the circular openings or holes is 3 mm. In some embodiments the diameter of the circular openings or holes is 4 mm. In some embodiments the diameter of the circular openings or holes is 5 mm. In some embodiments the diameter of the circular openings or holes is 6 mm. In some embodiments the diameter of the circular openings or holes is 7 mm. In some embodiments the diameter of the circular openings or holes is 8 mm. In some embodiments the diameter of the circular openings or holes is 9 mm. In some embodiments the diameter of the circular openings or holes is 10 mm. In some embodiments the diameter of the circular openings or holes is 11 mm. In some embodiments the diameter of the circular openings or holes is 12 mm. In some embodiments the diameter of the circular openings or holes is 13 mm. In some embodiments the diameter of the circular openings or holes is 14 mm. In some embodiments the diameter of the circular openings or holes is 15 mm. In some embodiments the diameter of the circular openings or holes is 16 mm. In some embodiments the diameter of the circular openings or holes is 17 mm. In some embodiments the diameter of the circular openings or holes is 18 mm. In some embodiments the diameter of the circular openings or holes is 19 mm. In some embodiments the diameter of the circular openings or holes is 20 mm. In some embodiments the diameter of the circular openings or holes is 21 mm. In some embodiments the diameter of the circular openings or holes is 22 mm. In some embodiments the diameter of the circular openings or holes is 23 mm. In some embodiments the diameter of the circular openings or holes is 24 mm. In some embodiments the diameter of the circular openings or holes is 25 mm. In some embodiments the diameter of the circular openings or holes is 26 mm. In some embodiments the diameter of the circular openings or holes is 27 mm. In some embodiments the diameter of the circular openings or holes is 28 mm. In some embodiments the diameter of the circular openings or holes is 29 mm. In some embodiments the diameter of the circular openings or holes is 30 mm. In some embodiments the diameter of the circular openings or holes is greater than 30 mm.

In some embodiments, the mesh or grate comprises a combination of different openings or holes of varying sizes or diameters. The skilled person would be able to select the appropriate mesh or grate in order to attain the desired CBD containing composition.

In some embodiments the speed of rotation of the agitator and/or the chamber can be varied according to the desired content of the CBD containing composition. In some embodiments the speed can be adjusted at 1 rpm, 2 rpm, 3 rpm, 4 rpm, 5 rpm, 6 rpm, 10 rpm, 15 rpm, 20 rpm, 25 rpm, 30 rpm, 35 rpm, 40 rpm, 45 rpm, 50 rpm, 55 rpm, 60 rpm, 65 rpm, 70 rpm, 75 rpm, 80 rpm, 85 rpm, 90 rpm, 95 rpm, 100 rpm, 105 rpm, 110 rpm, 115 rpm, 120 rpm or greater. The skilled person would be able to select the appropriate speed to attain the desired CBD containing composition.

In some embodiments the integrity of the hemp plant biomass and the seeds material is substantially disrupted as a result of the treatment. In some embodiments the integrity of the hemp plant biomass and the seeds material such as hemp plant seeds material, is substantially disrupted as a result of the treatment.

In some embodiments, at least 50% of the integrity of the hemp plant biomass and the hemp plant seeds material is disrupted. In some embodiments, at least 60% of the integrity of the hemp plant biomass and the hemp plant seeds material is disrupted. In some embodiments, at least 70% of the integrity of the hemp plant biomass and the hemp plant seeds material is disrupted. In some embodiments, at least 80% of the integrity of the hemp plant biomass and the hemp plant seeds material is disrupted. In some embodiments, at least 90% of the integrity of the hemp plant biomass and the hemp plant seeds material is disrupted. In some embodiments, at least 95% of the integrity of the hemp plant biomass and the hemp plant seeds material is disrupted. In some embodiments, at least 97.5% of the integrity of the hemp plant biomass and the hemp plant seeds material is disrupted. In some embodiments, at least 99% of the integrity of the hemp plant biomass and the hemp plant seeds material is disrupted. In some embodiments, 100% of the integrity of the hemp plant biomass and the hemp plant seeds material is disrupted.

In some embodiments, the different forces e.g. physical forces, create friction which lead to increase in heat or temperature in the immediate environment of the disrupted hemp plant biomass and the seeds material.

In some embodiments, the different forces e.g. physical forces which creates friction and concomitant increase in heat or temperature in the immediate environment of the disrupted hemp plant biomass and seeds material, leads to activation or release of the lipid or fat molecules in the hemp plant biomass and the seeds material.

Although the exact mechanism of mobilization or extraction of cannabinoids such as CBD and THC from the treated hemp plant biomass or hemp plant seeds material is not fully characterised, it is suggested that the activation or release of the lipid or fat molecules from the hemp plant biomass and seeds material such as hemp seeds material, is facilitating the mobilization or extraction of cannabinoids such as CBD and THC. A high complex lipid content from the seeds material seems to allow the use of the hemp plant biomass as a water-based product which may be extracted in hot water, room temperature water or even cold water as a water drink or water-based infusion.

In some embodiments, the different forces e.g. physical forces which are applied on the hemp plant biomass and seeds material, facilitates the mobilization or extraction of the aqua-phobic cannabinoids from the treated hemp plant biomass and hemp plant seeds material.

In some embodiments, the method for preparing the cannabinoid composition comprises at least one of a strain of hemp plant selected from a group consisting of a Cannabis indica strain, a Cannabis sativa, a hybrid strain, a low-CBD strain, a Cannabis sativa strain Finola.

In some embodiments, the method for preparing the cannabinoid composition comprises the hemp plant Cannabis sativa strain Finola.

In some embodiments, the method for preparing the cannabinoid composition comprises hemp plant biomass and hemp plant seeds material, where the hemp plant biomass is derived from one or more hemp plants. In some embodiments, the method for preparing the cannabinoid composition comprises hemp plant biomass and hemp plant seeds material, where the hemp plant seeds material is derived from one or more hemp plants. In some embodiments the plants from which the hemp plant biomass is obtained is different from the plants from which the hemp plant seeds are obtained.

In some embodiments, the method for preparing the CBD composition comprises hemp plant biomass and hemp plant seeds material where the hemp plant biomass and the hemp plant seeds material are derived from the same hemp plant.

In some embodiments, the different forces e.g. physical forces, create friction which leads to increase in heat or temperature in the immediate environment of the disrupted Cannabis sativa strain Finola biomass or hemp plant Cannabis sativa strain Finola seeds material.

In some embodiments, the different forces e.g. physical forces which creates friction and concomitant increase in heat or temperature in the immediate environment of the disrupted Cannabis sativa strain Finola biomass or hemp plant Cannabis sativa strain Finola seeds material, leads to activation or release of the lipid or fat molecules from the Cannabis sativa strain Finola biomass or hemp plant Cannabis sativa strain Finola seeds material.

In some embodiments, the different forces e.g. physical forces which are applied on the Cannabis sativa strain Finola biomass or hemp plant Cannabis sativa strain Finola seeds material, facilitates the mobilization or extraction of the aqua-phobic cannabinoids from the treated hemp plant biomass or hemp plant seeds material.

In some embodiments, the activation or release of the lipid or fat molecules from Cannabis sativa strain Finola biomass or hemp plant Cannabis sativa strain Finola seeds material, is facilitating the mobilization or extraction of cannabinoids such as CBD, CBDA and THC.

In some embodiments there is provided a cannabinoid containing composition as a starting material, an intermediate product or a component of a final product.

Since the methods for preparing a cannabinoid containing composition described herein do not involve or contemplate the use of, for example, different solvents or CBD oil extracts which may require these to be removed or eliminated, the cannabinoid composition may not require any further additives, surfactants or ingredients. In some embodiments the ingredients can be flavour modulators.

On some embodiment the method for preparing the cannabinoid composition further comprises an ingredient such as a flavour enhancing ingredient, off taste masking ingredient, flavour masking ingredient, off flavour masking ingredient, taste modulation ingredient or flavour modulation ingredient.

In some embodiment the method for preparing the cannabinoid composition further comprises an ingredient where the ingredient is at least one selected from the group of tea leaves, Lamiaceae species (including peppermint and spearmint), Verbascum species, Cinnamomum species, Elettatia cardamomum, plants of the Aquilaria genus, yarrow flower, Salvia species, Angelica species, catnip plants, lavender (Lavandula angustifolia), Taraxacum species, linden tree flowers, lemon verbena (Aloysia citrodora), gotu kola (Centella asiatica), Leonotis species, blue lotus (Nymphaea caerulea), kratom, herbal non-tobacco, mugwort, coltsfoot leaf, Heimia salicifolia, St. John's wort, Melissa officinalis, skullcap, yerba lenna yesca, Capillaris Herba, Calea zacatechichi, Leonurus sibericus, damiana, Withania somnifera, Mucuna pruriens, Celastrus paniculatus, Emblica officinalis, Terminalia chebula, Terminalia bellerica, Solanum xanthocarpum, Glycyrrhiza glabra, Ocimum sanctum, Zingiberaceae family and Zingiber officinale, a'hai, Commiphora mukul, Boswellia serrata, Vitex negundo, Bacopa monnieri, Cyperus rotundus, Myristica fragrans, Valeriana Nardostachys jatamansi, Mimosa hostilis, Avena sativa, kanna, Lactuca virosa, Cornus, pipsissewa (Chimaphila umbellata), pyrola, kinnikinnik, camomile, manzanita, Arctostaphylos species, madrone, Arbutus menziesii, Rubus species, scotch broom, calamus, Crocus sativus, Santalum album, Acacia confusa, Passifioraceae species, Echinacea purpurea and milk thistle (Silybum marianum).

In some embodiment, there is provided a cannabinoid containing composition obtained according to the methods described herein. In some embodiments the cannabinoid containing composition contains Cannabis sativa strain Finola biomass and hemp plant Cannabis sativa strain Finola seeds material. In some embodiments the Cannabis sativa strain Finola cannabinoid containing composition further comprises an ingredient such as a flavour enhancing ingredient, off taste masking ingredient, flavour masking ingredient, off flavour masking ingredient, taste modulation ingredient or flavour modulation ingredient.

The methods described herein prepare a cannabinoid containing composition with pleasant taste and aroma. The methods described herein prepare a cannabinoid containing composition with acceptable organoleptic properties.

In some embodiments the methods for preparing a cannabinoid containing composition comprises forming a cannabinoid product. In some embodiments the cannabinoid product is loose tea. In some embodiments the cannabinoid product is a tea bag.

In some embodiments the lose tea or tea bag can be used to make a water-based infusion. In some embodiments the water-based infusion has favorable, for example, taste or organoleptic characteristics. In some embodiments, the product is a water-based infusion. In some embodiments the tea bag contains 1.5 g of cannabinoid containing composition, the cannabinoid composition comprising Cannabis sativa strain Finola biomass and hemp plant Cannabis sativa strain Finola seeds material. In some embodiments the 1.5 g tea bag delivers 40 mg CBD/CBDA per 300 ml.

Disclosed herein is also a use of a cannabinoid product, the product comprising the cannabinoid composition prepared according to the methods described here, for making a water-based infusion.

Disclosed herein is also a water-based infusion obtained following use of the cannabinoid product comprising the cannabinoid composition prepared according to the methods described here.

In some embodiments, the tea bag or loose tea comprising the cannabinoid containing composition is steeped in boiling water.

In some embodiment the tea bag or loose tea comprising the cannabinoid containing composition is steeped in room temperature water (between 18° C. and 25° C.). In some embodiment the tea bag or loose tea is steeped in cold water (below 15° C.).

In some embodiments the loose tea or the tea bag comprise a final product.

In order that the invention may be readily understood and put into practical effect, particular embodiments will now be described by way of the following non-limiting examples.

The high complex lipid content from the seeds material allow the use of the hemp plant biomass as a water-based product which may be extracted in hot water, room temperature water or even cold water as a water drink or water-based infusion. It is expected that this is achieved because the hydrophobic cannabinoids from the plant biomass bind to the complex lipid molecules produced by the high quantity of seeds material so as to enable extraction in water, which would otherwise not be attainable.

### EXAMPLES

### Example 1—Hemp Plant and Growth Conditions

Different types of Cannabis genus plant, i.e. hemp plant, can be used in the present experiments. However, in order to illustrate the present methods one variety of hemp plant was selected namely Cannabis sativa strain Finola.

The chosen strain Finola was grown on organic farms in the Baltic region for example Lithuania and Estonia. The plants can be cultivated in greenhouses or outdoors. Preferably the plants are cultivated certified organic conditions.

The strain of Cannabis known as Finola is usually a variety grown for its seeds to be used in food or consumer products. These products were other than tea or for hemp seed oil extraction because that particular strain contains seeds which are high in fat.

The soils are carefully prepared and seeding for cultivation only commences when there is a consistent+8° C. soil temperature.

Fertilisers and their Uses

Fertilisers come in many forms as well as different formulas. Nitrogen, phosphorus, and potassium are the essential nutrients that Cannabis plants need from the soil. Since these are important for the quality of the plant these nutrients are added via a fertilizer such as organic fertilizer. An example of a fertilizer ratio of N—P—K (Nitrogen-Phosphorus-Potassium). This refers to the relative proportion of the major nutrients to one another. There are different ratios that may be chosen and those would be selected according to the desired outcome or CBD containing composition.

The choices can be based on a soil test. Routine soil or growing medium tests will show if any of the major nutrients are lacking. Supply of nutrients can be provided from several fertilizer sources or in combination with other types of nutrients. For example, when potassium and phosphorus are plenty in the growing medium/soil, a fertilizer with a ratio of around 3-1-2 should be sufficient. Three parts nitrogen to one part phosphorus to two parts potassium is frequently enough during Finola's Cannabis growth cycle.

By way of an illustrative example only, ratio of 15-9-12, shows 15% of the formulation is nitrogen, 9% is phosphorus, and 12% potassium.

Organic Fertilisers

This type of fertilizer builds up the growing medium and provides hemp plants with much needed nutrition. Organic fertilizers are usually obtained from organic materials, including animal, mineral and plant sources. Organic manures vary depending on the nutrient needs on the hemp plants. In most cases, organic manures are made up of a single ingredient. The ingredient and nutritional value of organic manures may not provide you with an immediate solution when compared to nonorganic manures.

What organic fertilizers do best is improve the fertility of growing medium and enhance the aeration, drainage, and texture of grow medium. Organic fertilizer is preferred for the present CBD containing compositions.

Inorganic Fertilisers

Inorganic fertilizers may also be used in preparing the hemp plant for the present invention.

Inorganic fertilizers are mainly composed of artificial ingredients. They are usually formulated from synthetic compounds or mined from mineral deposits. There are several types of nonorganic fertilizers on the market, including:

Specially formulated

Slow-release

Balanced

Complete

Phosphorus

Potassium

Nitrogen

All of these inorganic fertilizers would be available to the skilled person and can be employed in the methods of the present invention when culturing the hemp plants for the CBD containing composition.

### Example 2—Harvesting Time of Hemp Plant

A standardised reference recording the growth stages of a crop is useful for agronomists, physiologists, pathologists, breeders and, of course, for farmers.

As described herein, the general principles for a decimal code proposed by Zadoks et al., (1974) Weed Research 14: 415-421)) for cereals have been adjusted for hemp and will be relied upon for the present purposes.

In Table 1 there are provided a preferred list of definitions and codes of growth stages of Cannabis sativa L. plant such as Cannabis sativa L. Finola which show suitable for harvesting plants which can be used in the present methods. Cannabis sativa L. Finola was the plant from which the hemp plant biomass and the hemp plant seeds material were obtained. However, it is within the context of the present invention that the seeds material can be obtained from different plants such sunflower seeds, pumpkin seeds as detailed below.

TABLE 1

| | | |
|---|---|---|
| 2202 | Flowering | 50% of bracts formed |
| 2203 | Beginning of see maturity | First seeds hard |
| 2204 | Seed maturity | 50% of seeds hard |
| 2205 | End of seed maturity | 95% of seeds hard or shattered |

The Finola hemp plant variety is optionally harvested one month earlier than their normal growth cycle. This is because the CBD levels have reached their peak at that point and although the buds of the plant have formed, not all of the seeds have. By harvesting early in this manner, the methodology ensures not only a high level of cannabinoids but, significantly, also a high volume of seeds.

The hemp plants can be harvested by mechanical means or by hand. In the present experiment the plants are harvested by hand in order to try and protect the cannabinoid profile. Any use of mechanical harvesting would be too aggressive with the consequence that the cannabinoids which reside in the trichomes of the plants would be dislodged. After harvesting, the whole plant is then air dried for 2 days.

After the air drying stage, the buds and leaves are removed from the main stalk. The buds and leaves create biomass and it is the dried biomass which is then chopped, first by hand and then an activator apparatus or machine is used to apply motion and pressure to a blend of plant biomass and seeds against for example a <5 mm grate which allows smaller seeds to fall through, the biomass to be chopped to the optimum size for surface area and seeds material to be crushed which causes the excretion of high levels of fats into the chopped biomass.

### Example 3—Activator Apparatus

Removal of buds from stalks—This process is done when there is Cannabis/hemp placed into the feed hopper. Once the machine is turned on, the agitator will rotate. The friction of hemp plant matter rubbing against the mesh at the same time as being agitated will force separation of stalks from the buds.

Cut buds down to a finer product—This process is the same as above, however there are certain adjustments and parameters that are set up. The parameters are Screens sizes, Agitator speed and retention time.

Mix buds with seeds—This is part of all the above processes with adjustable parameters that are; Screens sizes and plant to seed ratio which is determined by the raw material used.

Activate fats via agitation. Due to the mechanical nature of the above processes, this creates friction. This friction then creates heat and that heat starts to change the fat molecules in the plant. This has parameters of screen size, retention time and agitator speed.

Parameter Details

Screen sizes can range from 1 mm to 16 mm width on square mesh 2 mm to 30 mm diameter if circle mesh. Agitator speeds can be adjusted from 1 rpm to 120 rpm depending on required result. Retention time is controlled by screen size parameters, agitator speed parameter and amount of plant placed into machine.

The apparatus simultaneously removes the seeds and biomass from the stalk. It does so in a manner which creates a predetermined ratio of crushed seeds to hemp plant biomass. It is the crushed seeds when reintroduced to the chopped hemp plant biomass which supplies the fats. A high fat or lipid content from the seeds seems to allow for the use of the plant as a tea product which may be extracted in hot water as a hot water drink or water-based infusion. It is hypothesized that this is achieved because the cannabinoids from the plant bind to the fat molecules produced by the high quantity of seeds so as to enable extraction in hot water, which would otherwise not be possible.

### Example 4

Predetermined Ratio and Cannabinoid Release in a Water-Based Infusion Product

The present methods describe cannabinoid containing compositions comprising hemp plant biomass and seeds material in a predetermined ratio. The hemp plant from which the biomass was derived is described in Example 2 above.

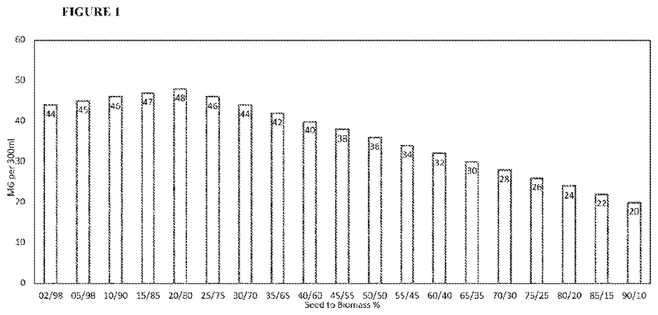

Depending on the predetermined ration it is possible to measure the amount of cannabinoid in water-based infusion as shown in FIG. 1. In the present experiment the predetermined ratios of seeds material to hemp plant biomass and the corresponding cannabinoid content in mg/300 ml of infusion were as follows:

75% by weight of seeds material to 25% by weight of hemp plant biomass—46 mg;

2% by weight of seeds material to 98% by weight of hemp plant biomass—44 mg;

5% by weight of seeds material to 95% by weight of hemp plant biomass—45 mg;

10% by weights seeds material to 90% by weight of hemp plant biomass—46 mg;

15% by weight of seeds material to 85% by weight of hemp plant biomass—47 mg;

20% by weight of seeds material to 80% by weight of hemp plant biomass—48% mg;

25% by weight of seeds material to 75% by weight of hemp plant biomass—46 mg;

30% by weight of seeds material to 70% by weight of hemp plant biomass—44 mg;

35% by weight of seeds material to 65% by weight of hemp plant biomass—42 mg;

40% by weight of seeds material to 60% by weight of hemp plant biomass—40 mg;

45% by weight seeds material to 55% by weight of hemp plant biomass—38 mg;

50% by weight of seeds material to 50% by weight of hemp plant biomass—36 mg;

55% by weight of seeds biomass to 45% by weight of hemp plant biomass—34 mg;

60% by weight of seeds material to 40% by weight of hemp plant biomass—32 mg;

65% by weight of seeds material to 35% by weights of hemp plant biomass—30 mg;

70% by weight of seeds material to 30% by weight of hemp plant biomass—28 mg;

75% of weight seeds material to 25% by weight of hemp plants biomass—26 mg;

80% by weight of seeds material to 20% by weight of hemp plant biomass—24 mg;

85% by weight of seeds material to 15% by weight of hemp plant biomass—22 mg; and

90% by weight of seeds material to 10% by weight of hemp plant biomass—20 mg.

Cannabinoids are aqua-phobic or water hating, with the consequence that for example CBD, CBDA or THC would not be readily bio-available in for example water-based solutions, were it not for the mobilization or activation of the fat or lipid molecules attained from the high ratio or proportion of seeds material in the cannabinoid containing compositions.

At the end of the process the chopped plant biomass mixed with a high proportion of fatty hemp seeds material is then either used directly as loose blend or put into a tea bag to create a custom blend of crushed or disrupted hemp plant biomass and hemp plant seeds material in a tea bag product.

It is also contemplated that chopped plant biomass mixed with a high proportion of fatty seeds material is then either used directly as lose blend or put into a teabag machine to create a custom blend of crushed or disrupted hemp plant biomass and seeds material in a teabag product.

If the product is a teabag, it would contain 1.5 g of the cannabinoid containing composition the composition comprising hemp plant biomass and hemp plant seeds material mixture, which in turn delivers 40 mg of CBD/CBDA per mug or cup (300 ml) when the tea is brewed as detailed below:

Place cannabinoid containing composition, for example a loose form composition or a tea bag, in a receptacle or directly in a cup or a teapot.

If using boiled water, heat until boiling and pour over cannabinoid containing composition. Surprisingly, however, it was also observed that room temperature water (between 18° C. and 25° C.) or even cold water (below 15° C.), can also be used with similar cannabinoid amounts being released into the water-based infusion, relative to the amounts released when using boiling water.

Steep the composition in the water for between 1 minute and 30 minutes. The cannabinoid infused water-based product is ready for consumption.

This cycle can be repeated up to three times with similar amounts of cannabinoids being released with each cycle.

The disclosure illustratively described herein can suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the disclosure claimed.

### REFERENCES

1. Hazekamp, Arno (2017). “Cannabis tea revisited: A systematic evaluation of the cannabinoid composition of Cannabis tea”. Journal of Ethnopharmacology. 113 (1): 85-90.
2. Zadoks et al., (1974) Weed Research 14: 415-421.
3. Mediavilla et al., 1998, Journal of the International Hemp Association 5(2):65, 68-74.

1. A method for preparing a cannabinoid containing composition, the method comprising:
a. providing hemp plant biomass;
b. providing seeds material; and
c. mixing the hemp plant biomass and the seeds material to a predetermined ratio of hemp plant biomass to seeds material.

2. A method for preparing a cannabinoid containing composition according to claim 1 wherein the hemp plant biomass has less than 20% moisture content (MC).

3. A method for preparing a cannabinoid containing composition according to claim 1, wherein the hemp plant biomass has 12% moisture content (MC).

4. A method for preparing a cannabinoid containing composition according to claim 1, wherein the seeds material has less than 20% moisture content (MC).

5. A method for preparing a cannabinoid containing composition according to claim 1, wherein the seeds material has 12% moisture content (MC).

6. (canceled)

7. A method for preparing a cannabinoid containing composition according to claim 1, wherein the hemp plant biomass and the seeds material are treated separately, sequentially or concomitantly.

8. A method for preparing a cannabinoid containing composition according to claim 7 wherein the integrity of the hemp plant biomass and the seeds material is substantially disrupted as a result of the treatment.

9. A method for preparing a cannabinoid containing composition according to claim 6 wherein at least 50% of the integrity of the hemp plant biomass and the seeds material is disrupted.

10. A method for preparing a cannabinoid containing composition according to claim 1 wherein the seeds material is derived from a group of plants comprising sunflower, pumpkin, jackfruit, cempedak, cocoa, coffee, durian, fox nut, hemp, lotus, poppy, pomegranate, watermelon, stone pine, single-leaf pinyon, Mexican pinuon, Korean pine, chingoza pine, pine nuts, monkey-puzzle, juniper, gnetum, ginkgo and cycads.

11. A method for preparing a cannabinoid containing composition according to claim 1 wherein the seeds material comprises immature seeds, mature seeds, hard seed, fragmented seeds or shattered seeds.

12. A method for preparing a cannabinoid containing composition according to claim 1 wherein the seeds material comprises lipid molecules.

13. A method for preparing a cannabinoid containing composition according to claim 12, wherein the lipid molecules comprise fatty acids such as Omega-6 and Omega-3 fatty acids, linoleic acid and alpha-linolenic acid.

14. A method for preparing a cannabinoid containing composition according to claim 13, wherein the fatty acids are selected from a group consisting of Omega fatty acids, Omega-6 and Omega-3, linoleic acid, alpha-linolenic, oleic acid and other mono-unsaturated, polyunsaturated and saturated fatty acids.

15. A method for preparing a cannabinoid containing composition according to claim 12, wherein the seeds material contains over 30% lipid molecules.

16. A method for preparing a cannabinoid containing composition according to claim 1 wherein the seeds material is derived from a sunflower plant or a pumpkin plant and comprises sunflower seeds material or pumpkin seeds material.

17. (canceled)

18. A method for preparing a cannabinoid containing composition according to claim 1, wherein the seeds material is derived from a hemp plant and comprises hemp plant seeds material.

19. (canceled)

20. A method according to claim 1, wherein the hemp plant is obtained from any one or more of the growth stages selected from a group of 2202, 2203, 2204 and 2205.

21. A method for preparing a cannabinoid containing composition according to claim 1, wherein the hemp plant is at least one of a strain of plants selected from a group consisting of a Cannabis indica strain, a Cannabis sativa, a hybrid strain, a low-CBD strain, a Cannabis sativa strain Finola.

22. (canceled)

23. A method for preparing a cannabinoid containing composition according to claim 1, wherein the predetermined ratio is about 75% by weight of seeds material to about 25% by weight of hemp plant biomass.

24. A method for preparing a cannabinoid containing composition according to claim 1, wherein the predetermined ratio is about 2% by weight of seeds material to about 98% by weight of hemp plant biomass.

25.-35. (canceled)
